(19) United States
(12) Patent Application Publication
(10) Pub. No.: US 2025/0001369 A1
(43) Pub. Date: Jan. 2, 2025

(54) MIXED-MATRIX MEMBRANES, COMPOSITION AND METHOD

(71) Applicants: The Regents of The University of Colorado, a body corporate, Denver, CO (US); TotalEnergies OneTech, Courbevoie (FR)

(72) Inventors: Douglas L. GIN, Denver, CO (US); Collin A. DUNN, Louisville, CO (US); Richard D. NOBLE, Denver, CO (US); Haïfa BEN HASSINE, Pau (FR)

(21) Appl. No.: 18/292,799

(22) PCT Filed: Jul. 29, 2021
(86) PCT No.: PCT/IB2021/000536

§ 371 Date: Jan. 26, 2024

(51) Int. Cl. B01D 69/14; B01D 53/22; B01D 71/02; B01D 71/82

(52) U.S. Cl. CPC B01D 69/148; B01D 53/228; B01D 71/0281; B01D 71/82; B01D 2257/504

(57) ABSTRACT

The invention relates to composition comprising: —at least one porous solid additive having a charged surface; —a charged interfacial agent; —a polymerizable ionic liquid monomer; wherein the charged interfacial agent is an ionic liquid (IL)-based oligomer comprising three or more repeated units. The invention also relates to a mixed-matrix membrane formed from the composition and a method of mixed-matrix membrane manufacture.

### FIELD OF THE INVENTION

The present invention relates to the field of gas separation using membranes. In particular, the invention relates to the field of mixed-matrix membranes. This invention provides a new membrane and method for improving gas separation.

### BACKGROUND OF THE ART

The global demand for natural gas is growing, as is the demand for technologies that can improve extracted gas to pipeline grade. In 2019, the United States alone consumed 846.6 billion m³ of natural gas, i.e. an increase of 3.3% in 2019 and 37% since 2009. The USA are the world's largest consumers with 21.5% of world consumption, far ahead of Russia (11.3%) and China (7.8%). (BP Statistical Review of World Energy 2020-69th edition and Statistical Review of world energy—June 2020).

Natural gas is primarily composed of methane (CH₄) but can contain heavier hydrocarbons, as well as water (H₂O), carbon dioxide (CO₂), hydrogen sulfide (H₂S), helium (He), and nitrogen (N₂). CO₂ is detrimental to gas quality, as it depresses the heating value of natural gas, and forms carbonic acid in the presence of water, which corrodes pipeline equipment.

Common methods for removing CO₂ include cryogenic distillation, pressure or temperature swing adsorption, amine scrubbing, and membrane separation. Currently, amine scrubbing is the dominant technology, while membranes account for only 5% of the separations market. However, scrubbing requires a significant energy cost to strip CO₂ from the amine salt and poses an environmental risk.

Compared to energy-intensive CO₂ separation methods such as amine scrubbing or adsorption processes, membrane-based separations are generally regarded as being more environmentally friendly, having a smaller footprint, and requiring lower capital and operating costs. A promising class of membrane materials for CO₂/CH₄ separations are mixed-matrix membranes (MMMs) that comprise a porous solid (such as a zeolite) in a polymer matrix.

Research in membrane gas separation, and in particular in MMMs, is focused on the development of membranes with high permeability and selectivity. Conventional MMMs are prepared from an addition of porous inorganic filler to polymer matrix. Indeed, MMMs were proposed as a strategy to utilize the excellent separation properties of zeolites into a more easily processable material. For example, MMMs preparation can consist of a zeolite incorporated into a rubbery polymer of poly(dimethylsiloxane).

However, it was rapidly determined that the performance of MMMs was limited by poor interfacial adhesion between the zeolite particles and the polymer matrix. Because the resulting interfacial void spaces are non-selective and provide a low-resistance route for gas transport, the CO₂/CH₄ separation potential of the first MMMs was severely limited. One possible solution to limit this effect is to produce MMMs with high zeolite loadings. These MMMs displayed significant selectivity enhancements. However, the high zeolite content reduced mechanical stability and produced brittle MMMs, which is unsuitable for the high-pressure differentials present in natural gas separations processes.

New MMMs have been produced by the in situ radical cross-linking of a mixture consisting of a polymerized ionic liquid (PIL), a free ionic liquid (IL), and a zeolite.

Ionic liquids (ILs) are organic molten salts that have a melting point below 100° C., preferably a melting point at room temperature. These ILs exhibit many properties that distinguish them from other liquids, including negligible vapor pressures, high thermal stability, and high solubility for a wide range of inorganic and organic compounds. Polymerized ionic liquids (PILs), are polymers with charged repeat units that are based on ILs (e.g. made from IL monomers). PILs are typically solid materials and thus have lower ion and gas diffusivity than ILs but similar gas solubility values and better mechanical stability.

Such MMMs have shown exceptional performance in separating CO₂ from CH₄ in low-pressure, single-gas testing (Bara et al. 2008. Improving CO₂ permeability in polymerized room-temperature ionic liquid gas separation membranes through the formation of a solid composite with a room-temperature ionic liquid. Polym. Adv. Technol. 2008; 19: 1415-1420). In particular it has been shown that the use of an IL both increase the permeability of the membrane, and to better facilitate interaction between the PIL and zeolite (Hudiono et al. 2010. A three-component mixed-matrix membrane with enhanced CO₂ separation properties based on zeolites and ionic liquid materials. Journal of Membrane Science 350 (2010) 117-123). Advantageously, the preparation of those MMMs involved radical polymerization via cross linking which is most convenient for industrial production and compatible with a large variety of functional groups or chain length compared to condensation polymerization, cationic polymerization or anionic polymerization.

Further studies shown that the presence of ILs in the polymer matrix will plasticize the PIL; thus, addition of IL into the polymer matrix increased the permeability of the studied composite membranes. The IL disrupts inter-chain packing and the PIL matrix becomes more rubbery. The polymer chains are therefore able to move more freely and have better interfacial interaction with the surface of the zeolite particles. This study shows that the presence of liquid IL in the 3-component MMMs improves the gas separation performance of the membranes by enhancing the adhesion interaction between the polymer matrix and zeolite surface (Hudiono et al. 2011. Novel mixed matrix membranes based on polymerizable room-temperature ionic liquids and SAPO-34 particles to improve CO₂ separation. J. Membr. Sci. 370 (2011) 141-148).

Moreover, it has been proposed to optimize the underlying factors responsible for reducing interfacial void space and improving the CO₂/CH₄ separation performance of PIL-IL-zeolite MMMs (Singh et al. 2016. Determination and optimization of factors affecting CO₂/CH₄ separation performance in poly(ionic liquid)—ionic liquid—zeolite mixed-matrix membranes. Journal of Membrane Science 509 (2016) 149-155). To control the interfaces between the three components in these MMMs, zeolite loading, zeolite type, PIL structure, and amount of polymer cross-linking have been varied. The effect of these variables on the CO2/CH4 separation performance have been studied and demonstrate an optimized MMM material with improved CO₂/CH₄ selectivity and permeability. Additionally, the mechanical stability of these MMMs has been demonstrated and these MMMs, based on a PIL-IL platform, has been recently processed in 100-nm-thick active layers. The combination of high CO₂/CH₄ separation performance, mechanical stability, and potential process ability is a significant breakthrough in materials for natural gas separations and make these MMMs attractive candidates for future applications to industrial CO₂/CH₄ separation.

However, when these MMMs were tested under mixed-gas, high-pressure, and/or high-temperature conditions, their CO₂/CH₄ selectivity's decreased dramatically. Additionally, when applied as thin films, these MMMs demonstrate severely reduced permeability. In particular, the lower observed CO₂/CH₄ selectivity values under higher-pressure, higher-temperature gas testing conditions may be caused by a delamination of the PIL matrix from the selective zeolite particles and formation of microscopic gas defects around them. Additionally, higher operating temperatures impede the adsorption of CO₂ onto the surface of the zeolite particles, further reducing the selectivity of these membranes at elevated temperatures. Little research has been published on mitigating selectivity losses in MMMs under mixed-gas feed conditions.

Hence, there is a need for new methods and optimized composition mixtures to generate MMMs with better CO₂/CH₄ separation selectivity and CO₂ permeability when used under mixed-gas, high-pressure, and/or high-temperature operating conditions and with lower cost system and more stable over time.

### Technical Problem

The invention aims to overcome the disadvantages of the prior art. One of the aims of this invention is to develop methods for optimizing the composition of these (PIL-IL-zeolite) mixtures to generate MMMs with better CO₂/CH₄ separation selectivity and CO₂ permeability when used under mixed-gas, high-pressure, and/or high-temperature operating conditions, and also MMMs less prone to the phenomena of plasticization and swelling.

In particular, the invention proposes a new composition with at least three components, said composition allowing generating MMMs with better selectivity and permeability in particular conditions as mixed-gas, high-temperature and high-pressure. The new composition also allows circumventing localized free IL deficiency. Also, the present disclosure proposes new MMMs and method of production thereof.

### SUMMARY OF THE INVENTION

The following sets forth a simplified summary of selected aspects, embodiments and examples of the present invention for the purpose of providing a basic understanding of the invention.

However, the summary does not constitute an extensive overview of all the aspects, embodiments and examples of the invention. The sole purpose of the summary is to present selected aspects, embodiments and examples of the invention in a concise form as an introduction to the more detailed description of the aspects, embodiments and examples of the invention that follow the summary.

The inventors developed an improvement in MMMs field by the use, in a particular MMMs composition, of a charged interfacial agent formed by an IL-based oligomer comprising three or more repeated units.

Hence, according to an aspect of the present invention, it is provided a composition comprising:
at least one porous solid additive having a charged surface;
a charged interfacial agent;
a polymerizable ionic liquid, preferably a polymerizable ionic liquid monomer;
wherein the charged interfacial agent is an ionic liquid (IL)-based oligomer comprising three or more repeated units. This composition is preferably dedicated to MMMs manufacture.

By replacing the traditional small-molecule IL with these IL oligomers, the viscosity of the “interfacial” component is increased. These oligomers in a polymer makes it possible to create a “graft polymer network” which is more resistant to plasticization and to swelling and therefore which makes it possible to generate MMMs with increased CO₂/CH₄ separation selectivity and permeability to CO₂, and particularly when these MMMs are used under mixed-gas, high-pressure, and/or high-temperature operating conditions. In addition, quite advantageously, such a composition makes it possible to reduce system costs and to be more stable over time (used longer).

According to other optional features of the composition, the latter may optionally include one or more of the following features, alone or in combination:
the ionic liquid-based oligomer is based on polymerized norbornene, oxanorbornene, styrene and/or acrylate moieties. Preferably, the IL-based oligomer is based on polymerized styrene and/or acrylate moieties.
the at least one porous solid additive is selected from zeolites, metal peroxides, zeolitic imidazolate frameworks and metal-organic frameworks.
it also comprises a cross-linker. In particular, the cross-linker will be used during the polymerization of the polymerizable ionic liquid.
the charged interfacial agent comprises an anion selected from the group consisting of Tf₂N⁻, BF₄⁻, N(CN)₂⁻, PF₆⁻, C(CN)₃⁻, B(CN)₄⁻, N(SO₂F)₂⁻, TfO⁻, SbF₆⁻, halide, and sulfonate.
the at least one porous solid additive is selected from zeolites, metal peroxides, zeolitic imidazolate frameworks and metal organic frameworks.
the at least one porous solid additive is selected from:
   Zeolites: Zeolites A, ZSM-5, Zeolite-13X, Zeolite-KY, Silicalite-1, SSZ-13, SAPO-34,
   MCM-41, MCM-48, SBA-11, SBA-12, SBA-15, mesoporous ZSM-5, activated carbon, TiO2, MgO; and/or
   MIL-96, MIL-100, MOF-5, MOF-177, ZIF-7, ZIF-8, Cu-TPA, Cu₃(BTC)₂, Cu-BPY-HFS.
it further comprises a cross-linker.
the polymerizable ionic liquid comprises less than 3 repeated units.

According to another aspect of the present invention, it is provided a mixed-matrix membrane formed from the composition of the invention. In particular, the invention relates to a mixed-matrix membrane comprising:
at least one porous solid additive having a charged surface;
a charged interfacial agent; and
a polymerized ionic liquid;
wherein the charged interfacial agent is an ionic liquid-based oligomer comprising three or more repeated units.

Preferably, the ionic liquid-based oligomer comprise twenty or less repeated units, more preferably ten or less repeated unites.

According to another aspect, the present invention relates to the use of a mixed-matrix membrane according to the invention, for gas separation, preferably for CO₂ separation.

According to other optional features of the composition, the latter may optionally include one or more of the following features, alone or in combination:
the use of the mixed matrix membrane for CO₂ separation, in a mixed gas, is at a pressure higher than 40 bars, preferably higher than 50 bars.
the use of the mixed matrix membrane for CO₂ separation, in a mixed gas, is at a temperature higher than 50° C., preferably higher than 60° C.
the use of the mixed matrix membrane for CO₂ separation, in a mixed gas, is at a pressure higher than 50 bars and a temperature higher than 60° C.

According to another aspect of the present invention, it is provided a method of mixed-matrix membrane manufacture comprising:
living chain-addition polymerization step based on a polymerizable ionic liquid comprising less than three repeated unit;
and a step of covering a solid porous additive having a charged surface with a charged interfacial agent, said charged interfacial agent being an IL based oligomer comprising three or more repeated units.

According to other optional features of the method, the latter may optionally include one or more of the following features, alone or in combination:
it comprises a step of controlling the living chain-addition polymerization.
it includes a ring-opening metathesis polymerization (ROMP) step, or a controlled radical polymerization (e.g., ATRP or RAFT) step.
it comprises a step of synthesis of a controlled-length IL oligomer.
it comprises a formation of ultrathin layer.

According to another aspect, the present invention relates to a separation system including a mixed-matrix membrane according to the invention, for example formed from a composition according to the invention, including any preferred or optional embodiment.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows an example of synthesis schemes for proposed controlled-length IL oligomer to replace small-molecule ILs in PIL/IL zeolite MMM preparation, based on RAFT.

FIG. 2 shows an example of an alternative synthesis scheme for proposed controlled-length IL oligomer to replace small-molecule ILs in PIL/IL zeolite MMM preparation, based on RAFT.

FIG. 3 shows an example of synthesis schemes for proposed controlled-length IL oligomer to replace small-molecule ILs in PIL/IL zeolite MMM preparation, based on ATRP.

### DETAILED DESCRIPTION

A description of example embodiments of the invention follows.

In the following description, “polymer” means either a copolymer (of the statistical, gradient, block, alternating type) or a homopolymer.

By “copolymer” is meant a polymer comprising several different or identical monomer units.

The term “oligomer” and similar terms as dimers, trimers, or heavy oligomers refer to oligomerization products containing, 2, 3, or more units derived from the monomer, respectively. The unit may be the same or different.

The term “monomer” as used refers to a molecule that can undergo polymerization.

The term “polymerization” as used refers to the chemical method of transforming a monomer or a mixture of monomers into a polymer of predefined architecture (block, gradient, statistical . . . ), a chemical reaction in which two or more molecules combine to form larger molecules that contain repeating structural units.

The expression “controlled polymerization” means a polymerization reaction which can be stopped.

The expression “chain-addition polymerization techniques” means polymerization without formation of a by-product—distinguished from condensation polymerization.

The expression “ring-opening metathesis polymerization” (ROMP) is a variant of the olefin metathesis reaction. The reaction uses strained cyclic olefins to produce monodisperse polymers and co-polymers of predictable chain length.

The expression “ionic liquid” (i.e., “IL”) as used herein can refers to a room-temperature molten salt that is comprised of cations and anions and that is liquid at 25° C. An IL according to the invention can be produced by melting a salt, and when so produced consists solely of ions. An IL may be formed from a homogeneous substance comprising one species of cation and one species of anion, or it can be composed of more than one species of cation and/or more than one species of anion. Thus, an IL may be composed of more than one species of cation and one species of anion. An IL may further be composed of one species of cation, and one or more species of anion. Still further, an IL may be composed of more than one species of cation and more than one species of anion. ILs are most widely known as solvents. IL refers to small molecule like single molecule or single unit. Preferably the IL is liquid at room temperature or over room temperature. IL may also be a non-polymerizable room temperature IL.

The expression “polymerizable ionic liquid” (i.e., “polymerizable IL” or “IL monomer”), refers to monomer or oligomer, preferably monomer, polymerizable at room temperature, preferably by radical polymerization. Such a polymerizable IL refers to an IL in which the cation or anion has a polymerizable group.

The term “charged” refers to a molecule or a mineral with positive and/or negative charges at different locations within that molecule or mineral.

The term “moiety” refers to a specific segment or functional group of a molecule. Chemical moieties are often recognized chemical entities embedded in or appended to a molecule.

The term “unsaturated,” as used herein, means that a moiety or a molecule has one or more units of unsaturation.

The term “saturated,” as used herein, means that a moiety or a molecule does not have one or more units of unsaturation.

The term “backbone” refers to the main chain of a polymer or copolymer or oligomer of the present invention.

The term “separation” (separation membrane) means a selective passage of certain molecules or ions in a mixture or not, between two media that it separates (by the membrane).

The part of the mixture retained by the membrane is called retentate (or concentrate) while that which crosses the latter is called the permeate. The separation takes place under the action of a driving force of transfer according to a defined separation mechanism. The characteristics of membranes are determined by two parameters: permeability and selectivity.

The term “selectivity” refers to a specificity feature with which the permeate is retained by the membrane. The selective permeability of a membrane means within the meaning of the present application that the membrane may control the entry and exit of molecules or ions between two media separated by the membrane.

The term “permeability” is a characteristic of the membrane which allows it to be penetrated, crossed, or traveled by molecules or ions, it is the ability to let itself be crossed by a fluid.

The term “mixed-gas” refers to a mixture of at least two gases.

The term “high pressure” refers to pressure greater than or equal to 40 bars, preferably greater than or equal to 50 bars.

The term “high temperature” refers to temperature greater than or equal to greater 50° C., preferably greater than or equal to greater 60° C.

The term “high viscosity” refers to viscosity greater than or equal to 5.10-3 Pa·s, preferably 1.10⁻² Pa·s, more preferably 5.10⁻² Pa·s, measured at 25° C., 1 atm for example by a viscometer.

The term “zeolite” can refer to any of the natural or synthesized or hydrated silicates or aluminosilicates which are formed of crystal structures mainly containing silicon, aluminum, oxygen, eventually phosphorous and metals, including titanium, tin, zinc.

The term “porous” can refer to a material having pore space, pore being as small interstices or opening admitting passage of molecules. A porous material, in particular a porous solid, may be mesoporous or microporous. According to IUPAC (International Union of Pure and Applied Chemistry), microporous corresponds to a size pore less than 2 nm (type zeolite or aluminophosphate), and mesoporous (silicas, alumina, carbons, metal oxides) corresponds to a size pore between 2 and 50 nm; size corresponding to the diameter.

The term “plasticization” refers generally to the softening or swelling of the polymer matrix by penetrant gases can be attributed to the swelling stresses on the polymer network. It is well known that sorption of carbon dioxide in glassy polymers can facilitate the local segmental organization with a reduction in the permselectivity and substantially affect membrane morphological performance. Hence, plasticization is a phenomenon that most frequently encountered in polymer-gas systems for commercial CO₂/CH₄ separation applications where the membranes are exposed to high CO₂ concentration in the feed stream.

The expression “thin-film composite membrane” refers to the membrane thickness itself. Preferably the thickness of the membrane is thinner than current mixed-matrix membrane. For example, the thickness of the mixed-matrix membrane is comprised between 0.05 μm and 50 μm, preferably, below 5 μm, more preferably below 2 μm.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements.

Additionally, it should be understood that references to “one embodiment” or “an embodiment” of the present disclosure are not intended to be interpreted as excluding the existence of additional embodiments that also incorporate the recited features.

As explain above current MMMs have reduced CO₂/CH₄ separation selectivity and CO₂ permeability when they are used under mixed-gas, high-pressure, and/or high-temperature operating conditions. More, current MMMs have free IL which tends to “pool” or aggregate more in the middle of the MMM film cross-section during casting, forming an ultrathin “drier” top “crust” and/or bottom surface next to the support film. Such “IL-deficient” regions are significantly rate-limiting with respect to overall gas permeation through the thickness of the TFC MMM. Additionally, small-molecule IL materials are not static in a polymer matrix and are potentially subject to physical displacement under high pressures. This result in a region of lower IL content near the feed-side membrane surface, thereby drastically slowing gas permeation in that region.

Moreover, under higher-pressure, higher-temperature gas testing conditions there is a plasticization and swelling of the organic polymerized IL and free IL (i.e., PIL+IL) matrix around the zeolite particles. This leads to delamination of the PIL (polymerized IL) matrix from the selective zeolite particles and formation of microscopic gas defects around them, resulting in lower selectivity.

Additionally, higher operating temperatures impede the adsorption of CO₂ onto the surface of the zeolite particles, further reducing the selectivity of these membranes at elevated temperatures. For improving the permeability of a thin film composite membrane, it may be possible to make the active layer thinner, and faster roll-to-roll casting may allow for better film homogeneity at a larger scale.

The inventors have developed a new composition and a new method for optimizing the composition of these mixtures to generate MMMs with better CO₂/CH₄ separation selectivity and CO₂ permeability when used under mixed-gas, high-pressure, and/or high-temperature operating conditions.

The invention will be described thereafter in the framework of separation of gas, in particular CO₂/CH₄ separation, it should be considered that the invention is not limited to CO₂/CH₄ and gas separation. The composition of the invention could be implemented with various fluids or plasma and in numerous different technical fields as filtration, purification, gas production, etc.

In particular, the inventors have developed a new mixture of polymerized IL/free IL and zeolite wherein the free IL is a charged interfacial agent which is an IL-based oligomer comprising three or more repeated units.

Hence, according to an aspect of the present invention, it is provided a composition, preferably for mixed-matrix membrane manufacture. The composition according to the invention may comprise:
at least one porous solid additive having a charged surface;
a charged interfacial agent; and
a polymerizable ionic liquid monomer.

The composition according to the invention advantageously comprises a charged interfacial agent. Preferably, the charged interfacial agent is an IL-based oligomer, said IL-based oligomer more preferably comprising three or more repeated units.

IL-based oligomer can comprise thirty or less repeated units, preferably twenty or less repeated units, more preferably fifteen or less repeated units, even more preferably ten or less repeated units.

Preferably, the IL-based oligomer is an organic salt that displays liquid properties at least at temperatures between 0° C. and 100° C.

Moreover, said IL-based oligomer is charged as it refers to a charged interfacial agent. Hence, an IL-based oligomer according to the invention can have multiple charges. For example, an IL-based oligomer will have at least 2 charges, preferably at least 3 charges.

The IL-based oligomer may comprise at least two IL moieties, preferably at least three IL moieties. IL oligomers with more IL moieties per repeat unit could also exhibit enhanced CO₂ solubility compared to a small molecule IL, and increasing the CO₂ permeance of new MMMs synthesized with the composition according to the invention.

Preferably, the IL-based oligomer may have a high affinity to CO₂. More preferably, the IL based oligomer may comprise a group having a high affinity to CO₂. In a particular embodiment, it will comprise at least one group having high affinity to CO₂ over other light gases. Other light gas can be selected for example from N₂, CH₄ and C₃H₈, preferably from N₂ and CH₄.

A molecule or a group, having a high affinity for CO₂ over other light gases can be identified through the use of Henry's constants (mole fractions). For example, a molecule, or a group, having a high affinity for CO₂ over other light gases can have a CO₂ Henry's Constant at 40° C. (atm) of at least 30, preferably of at least 40, more preferably of at least 50 and even more preferably of at least 70.

However, the IL-based oligomer used in the present invention have a high affinity for CO₂ can also be selected according to the volume of CO₂ solubilized in an experimental design at controlled temperature and pressure. Hence a IL-based oligomer having a high affinity for CO₂ can for example solubilize more than 0.1 mol of CO₂ per liter of IL-based oligomer. Preferably, a IL-based oligomer having a high affinity for CO₂ can solubilize more than 0.2 mol of CO₂ per liter of IL-based oligomer, more preferably more than 0.4 mol of CO₂ per liter of IL-based oligomer, even more preferably more than 0.5 mol of CO₂ per liter of IL-based oligomer.

In a preferred embodiment, the IL-based oligomer will comprise at least a functional group having a high affinity for CO₂. For example, a functional group having a high affinity for CO₂ can have an interaction energy with CO₂ lower than −10 kJ·mol⁻¹.

In a preferred embodiment, the IL based oligomer will comprise at least a functional group selected from imidazolium, pyridinium, quaternary ammonium, triazolium, pyrrolidinium, piperidinium, morpholinium, azole alkane, sulfonium and/or phosphonium.

Additionally, the charged interfacial agent may comprise an anion selected from the group consisting of Tf₂N⁻, BF₄⁻, N(CN)₂⁻, PF₆⁻, C(CN)₃⁻, B(CN)₄⁻, N(SO₂F)₂⁻, TfO⁻, SbF₆⁻, halide, and sulfonate.

In addition, IL oligomers with more IL fractions per repeat unit also exhibit improved CO₂ solubility over small molecule IL, increasing the CO₂ permeance of new MMMs synthesized with them.

The IL-based oligomer may be synthetized through polymerization involving norbornene, oxanorbornene, styrene and/or acrylate moieties.

In order to control uniformity and length, the composition is preferably prepared thanks to living ring-opening metathesis polymerization (ROMP) chemistry on norbornene and oxanorbornene monomers bearing Tf₂N⁻ imidazolium units to obtain uniform, length-controlled IL oligomers with alkyl backbones and more CO₂ soluble ether backbones (see FIG. 2 for some initial target IL oligomers).

Advantageously, ROMP is compatible with a wide range of chemical groups and has a high degree of molecular weight control and low polydispersity.

Alternatively, instead of using a living ROMP to prepare controlled-length IL oligomers from IL monomers containing a reactive norbornene or oxanorbonene group, controlled radical polymerization methods such as atom transfer radical polymerization (ATRP) and reversible addition-fragmentation chain-transfer (RAFT) can be used to prepare controlled-length IL oligomers from IL monomers containing a polymerizable styrene or acrylate group.

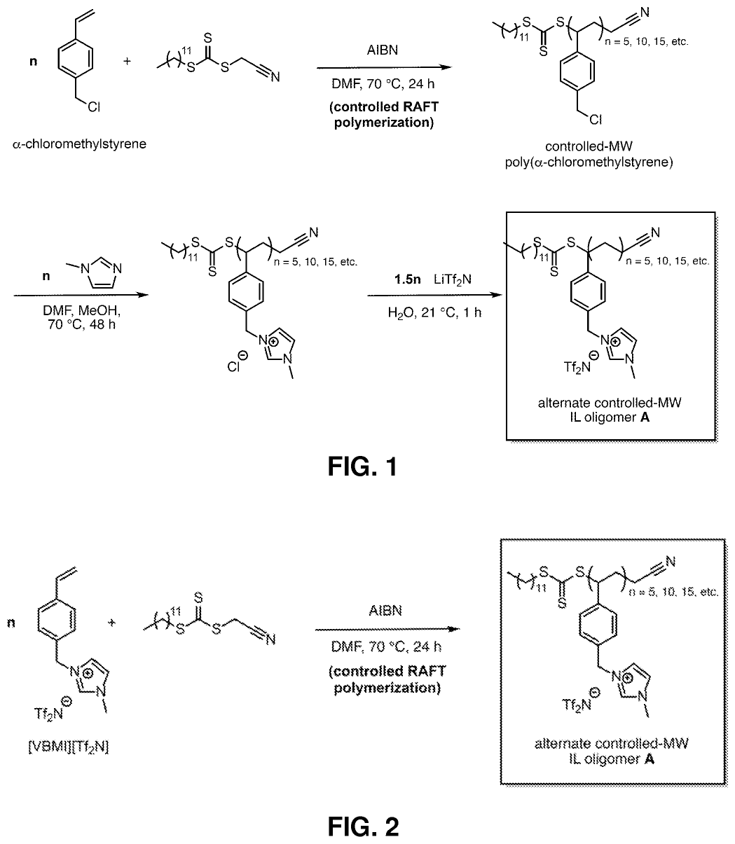

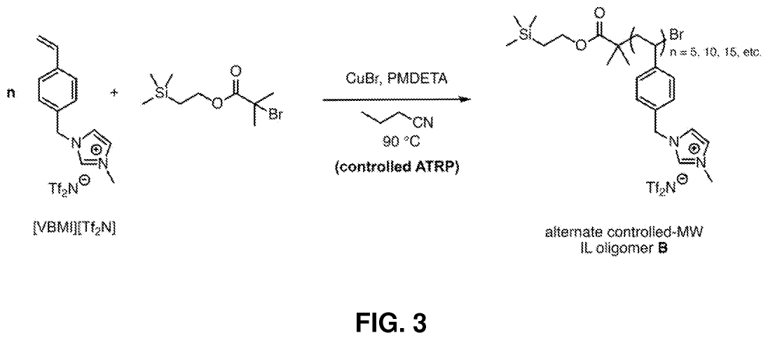

Such charged interfacial agents are illustrated in FIG. 1, FIG. 2 and FIG. 3.

These proposed IL oligomer (ionic liquid-based oligomer) compounds can be substituted for [EMIM][Tf₂N] (the current small-molecule free IL used in several MMM compositions) to prepare new MMM compositions.

Gas permeation studies on these new MMM compositions show that the use of IL oligomers instead of regular IL offers more resistance to stratification/settling and support penetration than [EMIM][Tf₂N]; and they improve the selectivity of the MMMs by resisting CO₂ plasticization at higher temperatures and gas pressures.

In order to circumvent localized free IL deficiency, the composition according to the invention proposes to replace the small-molecule free IL component in MMMs with higher-viscosity, low-molecular-weight IL oligomers of similar chemical and charged.

An IL oligomer made using living chain-addition polymerization techniques is more uniform in size and short enough to remain a liquid but viscous enough to resist “settling”, layer stratification, or support penetration during film casting.

According to the inventors, low viscosity small molecule IL materials are not static in a polymer matrix and are potentially subject to physical displacement under high pressures. This result in a region of lower IL content near the surface of the supply side membrane, thereby significantly slowing the permeation of gases in this region. The lower-than-expected gas permeances observed in tests may thus be due to “settling” or “wicking” of the small molecule IL interface agent during the initial solvent casting of the MMM.

The enhanced viscosities of these oligomers make them more resistant to flow, which work to avoid an IL concentration gradient near the feed side membrane surface due to the mechanical stress of 40 bars.

Advantageously, the IL-based oligomer may have a viscosity of more than 100 centipoises, when measured at 20° C. using an absolute viscometer. Optionally, the IL-based oligomer may have a molecular weight more than 500 g/mol-1, preferably more than 700 g/mol⁻¹, more preferably more than 1000 g/mol⁻¹. Moreover, the IL-based oligomer may have a molecular weight less than 5000 g/mol-1, preferably less than 4000 g/mol-1, more preferably less than 3000 g/mol⁻¹.

Moreover, advantageously, the IL-based oligomer do not comprise moieties which can react, in a radical polymerization reaction, with the polymerizable ionic liquid.

As stated, the composition for mixed-matrix membrane manufacture preferably comprises at least one porous solid additive having a charged surface.

The at least one porous solid may preferably be porous, either microporous or nanoporous.

More precisely, the at least one porous solid may be either mesoporous with size pores (diameter) between 2 and 50 nm, or, microporous with size pores less than 2 nm.

In particular, the porous solid additive can be a nanoporous solid additive or a microporous solid additive.

For example, the porous solid additive can be selected from zeolites, metal peroxides, zeolitic imidazolate frameworks and metal organic frameworks.

Preferably, the at least one porous solid may comprise a zeolite. According to the invention the at least one porous solid may be selected from zeolites, metal peroxides, zeolitic imidazolate frameworks and metal organic.

More preferably, when the at least one porous solid comprises zeolite, said zeolite comprises a silicoaluminophosphate, an aluminosilicate, a silicate, or an alkali metal aluminosilicate. Zeolite may also comprise Ge, Ga, Ti, V, Fe, or B.

Preferred zeolites can be selected from: Zeolites-A, ZSM-5, Eolite-13X, Zeolite-KY, Silicalite-1, SSZ-13, and SAPO-34.

Preferred mesoporous materials can be selected from: MCM-41, MCM-48, SBA-11, SBA-12, SBA-15, mesoporous ZSM-5, activated carbon, TiO₂, and MgO.

Zeolite can also comprise framework structure as MOFs.

MOFs are compounds having metal ions or clusters coordinated to organic molecules to form one-, two-, or three-dimensional structures that can be porous. By themselves, MOFs have been demonstrated to have very high gas sorption capacities, which suggest that gases generally will diffuse readily through MOFs if incorporated into a membrane. However, it has been discovered that MOFs attached to a polymeric membrane via a covalent or hydrogen bond or van der Waals interaction create membranes that improve on the permeability and selectivity parameters by virtue of being void-free or substantially void-free, where either no voids or voids of less than several Angstroms are present at the interface of the polymers and the MOFs. According to one embodiment, MOF may be chemical modified to use a linker that has a pendant functional group for post-synthesis modification.

In some embodiments, the MOFs are zeolitic imidazolate frameworks (ZIFs). ZIFs are a subclass or species of MOFs and have attractive properties such as high specific surface area, high stability, and chemically flexible framework.

In a further aspect, the imidazolate structures or derivatives can be further functionalized to impart functional groups that line the cages and channel, and particularly the pores to obtain a desired structure or pore size.

The composition according to the invention also comprises a polymerizable ionic liquid, such as a polymerizable ionic liquid monomer.

The polymerizable IL may comprise less than 3 repeating units.

Preferably, the polymerizable IL may comprise at least one polymerizable group configured to react in a radical polymerization reaction with a polymerizable group of another polymerizable IL to form a polymer and at least one group having high affinity to CO₂ over other light gas, preferably said at least one group having high affinity to CO₂ comprise phosphonium; ammonium; imidazolium; and/or pyridinium.

The composition can comprise at least two polymerizable IL monomer in order to form a block co-polymer in the mixed-matrix membrane.

In particular, according to one embodiment of the present invention, the composition may comprise a cross-linker.

Moreover, by using an optimized amount of more-CO₂-selective cross-linkers for preparation of the PIL matrix in these MMMs, CO₂ plasticization that leads to reduced CO₂/CH₄ selectivity under higher temperature and higher-CO₂-pressure operating condition will be reduced or mitigated.

As stated, by replacing the “free IL” component with these IL oligomers, the viscosity of the ‘interfacial’ component will be increased. This makes it less that the material is either lost to the underlying support, or ‘settles’ and creates a nonhomogeneous distribution of interfacial agent across the membrane length. Additionally, blending these oligomers into a polymer create a ‘grafted polymer network’ which is more resistant to plasticization and swelling.

The cross-linker may comprise at least two polymerizable groups configured to react, in a radical polymerization reaction, with the polymerizable IL monomer, said polymerizable groups preferably containing a double bond.

The cross-linker may also comprise at least one polar group.

Several polymerization and cross-link solution have been proposed. Inventors determined that in the context of the present invention, a cross-linker comprising at least two polymerizable groups configured to react in a radical polymerization reaction will provide the best results.

Advantageously, the cross-linker may comprise at least one group having high affinity to CO₂ over other light gases.

A high affinity can be considered as an affinity for CO₂ higher than the affinity for CO₂ of a benzene cycle.

In a preferred embodiment, the cross-linker will comprise at least a functional group having a high affinity for CO₂. For example, a functional group having a high affinity for CO₂ can have an interaction energy with CO₂ lower than −10 kJ·mol⁻¹.

In a preferred embodiment, the cross-linker will comprise at least a functional group selected from:
a functional group comprising at least one π bond involving a heteroatom,
imidazolium, pyridinium, quaternary ammonium, triazolium, pyrrolidinium, piperidinium, morpholinium, azole alkane, sulfonium, phosphonium; and/or
A polar group such as ethylene glycol, polyol, fluoroalkyl, aromatic ring or nitrile.

According to another aspect, the present invention concerns a mixed-matrix membrane, preferably for gas separation. The mixed-matrix membrane is formed from the composition according to the invention.

In particular, such a mixed-matrix membrane comprises:
at least one porous solid additive having a charged surface;
a charged interfacial agent; and
a polymerized ionic liquid;
wherein the charged interfacial agent is an ionic liquid-based oligomer comprising three or more repeated units.

The mixed-matrix membrane may be used for gas separation, permitting passage of desired gaseous components, preferably carbon dioxide and methane.

The membrane may permit the passage of gaseous components at different diffusion rates, such that one of the components, for example either carbon dioxide or methane, diffuses at a faster rate through the membrane. In a preferred embodiment, the rate at which carbon dioxide passes through the polymer is at least 10 times faster than the rate at which methane passes through the polymer.

The mixed-matrix membrane with the charged interfacial agent as an IL-based oligomer comprising three or more repeated units allow the membrane to present a better CO₂/CH₄ separation selectivity and CO₂ permeability.

For improving the permeability of the membrane, it may be possible to make an active layer thinner, and faster roll-to-roll casting may allow for better film homogeneity at a larger scale.

Generally, the thickness of the thin membrane can be selected such that the mechanical stability of the membrane is suitably improved.

The higher the thickness of the thin membrane, the lower is the permeability of the thin membrane. Therefore, the thickness is selected such that an acceptable compromise between the permeability and the mechanical stability is achieved.

The membrane may be rigid, rubbery, or flexible.

The mixed matrix membrane is preferably in the form of a film, tube or other conventional shapes used for gas separations.

According to another aspect, the present invention concerns a separation system including a membrane according to the invention.

A separation system is preferably a gas separation system.

The separation system may include an outer perforated shell surrounding one or more inner tubes that contain the mixed-matrix membranes.

The separation system may also comprise at least an inlet and at least an outlet. The inlet allows feeding the system in fluid, preferably gas, and the outlet, the contaminants to leave.

For example, the gaseous mixture passes upward through the inner tubes. As the gaseous mixture passes through the inner tubes, one or more components of the mixture permeate out of the inner tubes through the mixed-matrix membrane.

The mixed-matrix membranes can be included in a cartridge and used for permeating contaminants from a gaseous mixture. The contaminants can permeate out through the membrane, while the desired components continue out of the top of the membrane. The membranes may be stacked within a perforated tube to form the inner tubes or may be interconnected to form a self-supporting tube.

Each one of the mixed-matrix membranes may be designed to permeate one or more components of the gaseous mixture.

The membranes may be removable and replaceable in a system. So, the system may also comprise membrane arranged in series, in parallel or in combinations.

Advantageously, a separation system including the membranes may be of a variable length.

The gaseous mixture can flow through the membrane(s) following an inside-out flow path or following an outside-in flow path.

The membranes are preferably durable, resistant to high temperatures, and resistant to high pressure as explained, so the system is also more resistant and more durable over time.

According to another aspect, the present invention concerns a method of mixed-matrix membrane manufacture.

MMMs can be formed by any method allowing polymerization, preferably radical. More preferably, the MMMs can be formed by a ROMP.

Advantageously, ROMP is compatible with a wide range of chemical groups and has with a high degree of molecular weight control and low polydispersity.

The method according to the invention comprises:
living or controlled chain-addition polymerization step based on a polymerizable IL monomer comprising less than three repeated unit,
and a step of covering at least one porous solid additive having a charged surface with a charged interfacial agent, said charged interfacial agent being an IL-based oligomer comprising three or more repeated units.

As already stated, the IL-based oligomer with three or more repeated unit allows mitigating the plasticization.

The method according to the invention may comprise a step of synthesis of the charged interfacial agent through the synthesis of a controlled length IL oligomer, a ring-opening metathesis polymerization (ROMP) step, and a step of control of chain addition polymerization.

Preferably, the control of the length of the charged interfacial agent is based on a ring-opening metathesis polymerization (ROMP) or on control of chain addition polymerization. The use of IL-based oligomers, with three or more repeated unit, in place of small-molecule ILs in MMMs preparation allow improving gas permeance and selectivity.

In addition, the use of IL-based oligomers (i.e. controlled-length IL oligomers) allows reducing aggregation in the middle of the MMM film cross-section during casting. Advantageously, the controlled-length IL oligomers avoid “IL-deficient” regions. IL oligomer having more than three repeated unit, no more free IL are present, and controlled-length oligomer are more static than free IL and less subject to physical displacement under high pressure. This leads of mixed-matrix membrane with a homogeneous repartition, and thus considerably improving gas permeation.

An IL-based oligomer made using living or controlled chain-addition polymerization techniques such as ROMP, ATRP, and RAFT have uniform size and short enough to remain a liquid but viscous enough to resist “settling”, layer stratification, or support penetration during film casting.

Additionally, the resulting mixed-matrix membrane is similar to a grafted polymer, which better resists plasticization and swelling.

In order to improve the method, ROMP step may be performed on simple imidazolium-based norbornene monomers to make uniform, low-molecular-weight IL oligomers and block copolymers, including the first type of proposed IL oligomer shown in FIG. 1.

ROMP is a chain-growth polymerization which converts cyclic olefins to a polymeric material in the presence of transition metal-based complexes such as Ti, Mo, W, Ta, Re, Ru. ROMP is a type of olefin metathesis polymerization in which the driving force of the reaction is relief of ring strain in cyclic olefins (e.g., norbornene or cyclopentene). Therefore, transformation reactions of both polycyclic olefins such as norbornene; norbonadiene; dicyclopentadiene and low-strain cyclic olefins including cyclopentene; or cycloheptene allow extension of the range of attainable chain polymer.

In ROMP, the monomer can include a strained ring functional group, such as a norbornene functional group, a cyclopentene functional group, etc., to form the polymeric chains. For example, norbornene is a bridged cyclic hydrocarbon that has a cyclohexene ring bridged with a methylene group in the para position.

In a ROMP process, formation of a metal-carbene species is followed by attack of the double bond in the ring structure by the carbene, forming a highly strained metallacyclobutane intermediate. The ring then opens, giving the beginning of the polymer: a linear chain double-bonded to the metal with a terminal double bond as well. The new carbene reacts with the double bond on the next monomer, thus propagating the reaction.

The crucial step in ROMP for synthesis is the chain-transfer process during the termination. ROMPs are widely terminated by the addition of an agent containing certain functional groups.

This agent provides deactivation of the transition metal catalyst from the end of propagating chain and selective insertion of a functional group.

It is important to note that, as with all metathesis reactions, all steps are in principle reversible. Furthermore, the double bond of the monomer is formally preserved, resulting in one double bond per repeat unit. This high unsaturation of the resulting ROMP affects the stability versus oxygen of the resulting polymers.

Alternatively, instead of using a living ROMP to prepare controlled-length IL oligomers, controlled radical polymerization methods such as atom-transfer radical polymerization (ATRP) and reversible addition-fragmentation chain-transfer (RAFT) polymerization can be used.

### Example

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

As it has been detailed, the invention comprises the use of an ionic liquid (IL)-based oligomer in a MMM. These examples are in particular directed to such an aspect.

### 1. Materials

CO₂, CH₄, and He gas were purchased from Airgas, and of ultra-high purity (99.999%).

1-Vinyl-3-methylimidazolium bis(triflimide) ([VMIM][Tf₂N]) and 1-ethyl-3-methylimidazolium bis(triflimide) ([EMIM][Tf₂N]) were synthesized according to previously published literature methods (S. Li, J. L. Falconer, R. D. Noble, Improved SAPO-34 Membranes for CO₂/CH₄ Separations, Adv. Mater. 18, (2006) 2601-2603. https://doi.org/10.1002/adma.200601147), and their structures were confirmed via ¹H NMR spectroscopy and matched reported characterization data (Li et al., 2006).

The cross-linking compound divinylbenzene (DVB) and the radical photo-initiator such as the 2-hydroxy-2-methlpropiophenone (HMP) were purchased from Sigma-Aldrich and used as received.

SAPO-34 is synthesized using a procedure reported in prior literature (Y. Zheng, N. Hu, H. Wang, N. Bu, F. Zhang, R. Zhou, Preparation of steam-stable high-silica CHA (SSZ-13) membranes for CO₂/CH₄ and C₂H₄/C₂H₆ separation, J. Membr. Sci. 475 (2015) 303-310. https://doi.org/10.1016/j.memsci.2014.10.048). SAPO-34 is calcined at 600° C. and finely ground via mortar and pestle prior to use.

### 2. Ionic Liquid (IL)-Based Oligomer

The performance of MMMs comprising [VMIM][Tf₂N] or [EMIM][Tf₂N] can be compared to the performance of MMMs comprising instead IL-based oligomers.

Several molecules which can be used as IL-based oligomers. IL-based oligomers can be synthesized using a ring-opening metathesis polymerization (ROMP).

Alternatively, IL-based oligomers can be synthetized using controlled radical polymerization methods such as ATRP and RAFT. These techniques are efficient and scalable methods for making controlled-length IL oligomers in particular from IL-based styrene and/or acrylate monomers.

### RAFT

As shown in FIG. 1, IL-based oligomers can be synthesized via controlled RAFT polymerization.

In particular, the controlled sequential polymerization can use α-chloromethylstyrene (CMS), cyanomethyldodecyl trithiocarbonate as the chain-transfer agent, azobis(isobutyronitrile) (AIBN) as the radical initiator, and N,N-Dimethylformamide (DMF) as the polymerization solvent.

Purified CMS is dissolved in DMF and added to a Schlenk flask equipped with a magnetic stir bar. The RAFT agent cyanomethyldodecyl trithiocarbonate is then added to the flask. AIBN is then added to the flask, and stirring is started to mix the reagents. A blanket of Ar gas is passed into the flask to displace the outside atmosphere. The contents of the reaction flask are degassed by repeated free-pump-thaw cycles using liquid nitrogen until negligible pressure increase is detected on evacuation. Once the final thaw cycle is complete, Ar gas is flowed into the flask under positive pressure, and a reflux condenser was attached. The condenser is sealed, and the Ar flow shut off. The sealed reaction system then is placed in an oil bath set to a temperature of 70° C., and the contents stirred rapidly. After stirring for 24 h at that temperature, the reaction flask is removed from heat and allowed to cool to ambient temperature. The polymer solution is then added dropwise into 1-L Erlenmeyer flask containing 700 mL of rapidly stirred methanol. The precipitated poly-CMS oligomer appear as light yellow ‘chips’ of solid matter. After the methanol is decanted and the poly-CMS oligomer is dried overnight in in vacuo at 40° C.

IL oligomer is prepared by reacting poly-CMS oligomer with an excess of N-methylimidazole to ensure all chloromethyl groups are substituted with IL moieties. Poly-CMS oligomer is added along with DMF to a 50-mL round-bottom flask equipped with a magnetic stir bar. This mixture is stirred until the polymer completely dissolved. A reflux condenser is attached to the flask, and the flask is heated to 70° C. and held at that temperature. N-Methylimidazole and methanol are then added to the flask, without letting it cool, so as to avoid irreversible gelation of the reaction mixture. This reaction is run under reflux at 70° C. for 24 h to afford the Cl—intermediate curable polymer. Intermediate polymer, is dissolved in 50 mL of deionized (DI) H₂O. A 1.5 times molar excess of LiTf₂N (11.0 g, 38.32 mmol) is dissolved in 350 mL of DI H₂O. The aqueous solution of intermediate polymer is added dropwise to the rapidly stirred LiTf₂N solution, and an off-white gum immediately formed. This new precipitate is the Tf₂N⁻-substituted curable IL oligomer.

Alternatively, as shown in FIG. 2, IL-based oligomers can be synthesized via controlled RAFT polymerization of an IL comprising a vinylbenzyl (such as [VBMI][Tf2N]) using cyanomethyldodecyl trithiocarbonate as the chain-transfer agent, azobis(isobutyronitrile) (AIBN) as the radical initiator, and N,N-Dimethylformamide as the polymerization solvent. Briefly, purified [VBMI][Tf2N] is dissolved in DMF and added to a Schlenk flask equipped with a magnetic stir bar. The RAFT agent cyanomethyldodecyl trithiocarbonate is then added to the flask. AIBN is then added to the flask, and stirring is started to mix the reagents. A blanket of Ar gas is passed into the flask to displace the outside atmosphere. The contents of the reaction flask are degassed by repeated free-pump-thaw cycles using liquid nitrogen until negligible pressure increase is detected on evacuation. Once the final thaw cycle is complete, Ar gas is flowed into the flask under positive pressure, and a reflux condenser was attached. The condenser is sealed, and the Ar flow shut off. The sealed reaction system then is placed in an oil bath set to a temperature of 70° C., and the contents stirred rapidly. After stirring for 24 h at that temperature, the reaction flask is removed from heat and allowed to cool to ambient temperature. The polymer solution is then added dropwise into 1-L Erlenmeyer flask containing 700 mL of rapidly stirred methanol. The precipitated is the IL oligomer.

### ATRP

As shown in FIG. 3, IL-based oligomers can be synthesized via ATRP using CuBr/N,N,N′,N′,N″-pentamethyldiethylenetriamine (PMDETA) as the catalyst system and 2-(trimethylsilyl)ethyl 2-bromo-2-methyl-propanoate as the initiator in butyronitrile solution.

IL monomer such as [VBMI][Tf2N], PMDETA, and butyronitrile are added to a flame-dried Schlenk flask and degassed by three freeze-pump-thaw cycles. After the flask are allowed to warm to room temperature and back-filled with Ar and CuBr is added. The resulting mixture is stirred at room temperature for 30 min, and eventually a macro-initiator comprising a styrene is added. The flask is then placed in a 90° C. oil bath and stirred. Upon complete consumption of IL monomer (as verified by 1H NMR analysis), the resulting reaction mixture is purified to give an IL-based oligomer.

Similar polymerizations can also be done via ATRP and RAFT using analogous IL-based acrylate monomers (not shown).

### 3. MMM Synthesis

Free-standing MMMs are synthesized by combining appropriate weight ratios of polymerizable IL, such as polymerizable IL monomers, charged interfacial agent and porous solid additive having a charged surface (such as SAPO-34).

This mixture is stirred for 24 h, followed by the addition of 0.5 to 6 wt % crosslinker (based on the IL-based components' total mass), and 0.5 to 2 wt % of a radical photo-initiator such as 2-hydroxy-2-methlpropiophenone (based on the IL-based components' total mass).

This mixture is stirred briefly before being cast onto a quartz plate treated with Rain-X™. Two 150-μm-thick glass slides are used as spacers, and a second Rain-X™_treated plate is laid on top of the mixture, producing a membrane film. The plates are clamped together and irradiated with a 365-nm UV lamp (4.3 mW/cm² at the sample surface) for 5 h at 17° C. The plates are then separated and placed in a 50° C. vacuum oven (20 torr) for 24 h.

The membrane is then peeled from one of the plates, placed in a Petri dish, and either stored under static vacuum or immediately prepared for gas permeability evaluation. A digital micrometer can be used to measure the thickness of the resulting free-standing MMM films, which usually ranged from 120 to 160 μm.

Reference MMM films are produced with free IL and MMM films of the invention are produced with ionic liquid (IL)-based oligomer comprising three or more repeated units. Ionic liquid (oligomer or not) are preferably added at loading levels such that the resulting MMMs contain an equivalent number of imidazolium groups.

### 2.3. Gas Permeability Measurements

The gas permeabilities of the MMM samples are measured using a custom-built apparatus equipped for high pressures and binary gas feeds using the following procedure: A circular piece of membrane is loaded into the bottom half of a steel testing cell, a rubber gasket is placed on top of it, and the top half of the cell is laid on top and secured with screws. A pair of mass flow controllers (MFCs) attached to CO₂ and CH₄ cylinders allow the feed flowrate and composition to be controlled via LabView software. The feed flowrate is orders of magnitude higher than the permeation rate, allowing the feed and retentate composition to be assumed equal.

A third MFC is used to provide a sweep stream of He to the permeate side of the membrane. Both the feed/retentate stream and the permeate stream are monitored by an in-line SRI 8610C gas chromatograph (GC) equipped with a 6-m-long Haysep D column operating at 50° C. A back-pressure regulator on the feed side is used to select the feed pressure, and digital gauges monitored the pressure on the feed and permeate streams. Permeate and retentate flowrates are determined using bubble flow meters and a stopwatch. The membrane cell rested inside a Yamato DX 300 oven to perform gas permeation measurements on the MMM samples at different elevated temperatures. The combination of GC composition data, flowrates, and pressures is used to calculate each MMM sample's CO₂ and CH₄ permeabilities, as well as CO₂/CH₄ selectivity.

Such experiment can confirm that MMMs according to the invention are designed to mitigate the issue of CO₂ plasticization and reduce swollen by CO₂ at higher pressures and temperatures. Moreover, MMMs according to the invention have high CO₂ permeability, as well as high CO₂/CH₄ selectivity.

The recitation of a listing of elements in any definition of a variable herein includes definitions of that variable as any single element or combination (or subcombination) of listed elements. The recitation of an embodiment herein includes that embodiment as any single embodiment or in combination with any other embodiments or portions thereof.

The disclosures of each and every patent, patent application, and publication cited herein are hereby incorporated herein by reference in the entireties, except for any definitions, subject matter disclaimers or disavowals, and except to the extent that the incorporated material is inconsistent with the express disclosure herein, in which case the language in this disclosure controls.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. A composition comprising:
a porous solid additive having a charged surface;
a charged interfacial agent; and
a polymerizable ionic liquid;
wherein the charged interfacial agent is an ionic liquid (IL)-based oligomer comprising three or more repeated units.

2. The composition according to claim 1, wherein the IL-based oligomer is based on polymerized norbornene, oxanorbornene, styrene and/or acrylate moieties.

3. The composition according to claim 1, wherein the IL-based oligomer is based on polymerized styrene and/or acrylate moieties.

4. The composition according to claim 1, wherein the charged interfacial agent comprises an anion selected from the group consisting of Tf₂N⁻, BF₄⁻, N(CN)₂⁻, PF₆⁻, C(CN)₃⁻, B(CN)₄⁻, N(SO₂F)₂⁻, TfO⁻, SbF₆⁻, halide, and sulfonate.

5. The composition according to claim 1, wherein the porous solid additive is selected from zeolites, metal peroxides, zeolitic imidazolate frameworks and metal organic frameworks.

6. The composition according to claim 1, wherein the porous solid additive is selected from:
Zeolites, Zeolites A, ZSM-5, Zeolite-13X, Zeolite-KY, Silicalite-1, SSZ-13, SAPO-34;
MCM-41, MCM-48, SBA-11, SBA-12, SBA-15, mesoporous ZSM-5, activated carbon, TiO2, MgO; and
MIL-96, MIL-100, MOF-5, MOF-177, ZIF-7, ZIF-8, Cu-TPA, Cu₃(BTC)₂, Cu-BPY-HFS.

7. The composition according to claim 1, further comprising a cross-linker.

8. The composition according to claim 1, wherein the polymerizable ionic liquid comprises less than 3 repeated units.

9. A mixed-matrix membrane formed from the composition of claim 1.

10. A mixed-matrix membrane comprising:
a porous solid additive having a charged surface;
a charged interfacial agent; and
a polymerized ionic liquid;
wherein the charged interfacial agent is an ionic liquid-based oligomer comprising three or more repeated units.

11. A method comprising separating CO₂ from mixed gas via the mixed-matrix membrane according to claim 9.

12. The method according to claim 11, said CO₂ being separated from said mixed gas at a pressure higher than 40 bars.

13. The method according to claim 11, said CO₂ being separated from said mixed-gas at a temperature higher than 50° C.

14. The method according to claim 11, said CO₂ being separated from said a mixed-gas at a pressure higher than 50 bars and a temperature higher than 60° C.

15. A method of mixed-matrix membrane manufacture comprising:
a living chain-addition polymerization step based on a polymerizable ionic liquid comprising less than three repeated units, and
a step of covering a porous solid additive having a charged surface with a charged interfacial agent, said charged interfacial agent being an ionic-liquid based oligomer comprising three or more repeated units.

16. The method of mixed-matrix membrane manufacture according to claim 15, further comprising a step of controlling the living chain-addition polymerization.

17. The method of mixed-matrix membrane manufacture according to claim 16, further comprising a step of synthesis of a controlled-length ionic-liquid oligomer.

18. The method of mixed-matrix membrane manufacture according to claim 15, further comprising a ring-opening metathesis polymerization (ROMP) step.

19. The method of mixed-matrix membrane manufacture according to claim 15, a further comprising formation of ultrathin layer.

20. A separation system including the mixed-matrix membrane according to claim 9.
